(19) United States
(12) Patent Application Publication
(10) Pub. No.: US 2015/0066378 A1
(43) Pub. Date: Mar. 5, 2015

(54) Identifying Possible Disease-Causing Genetic Variants by Machine Learning Classification

(71) Applicant: Tute Genomics, Provo, UT (US)

(72) Inventors: Reid Robison, Salt Lake City, UT (US); Kai Wang, Los Angeles, CA (US)

(73) Assignee: Tute Genomics, Provo, UT (US)

(21) Appl. No.: 14/470,628

(22) Filed: Aug. 27, 2014

Related U.S. Application Data
(60) Provisional application No. 61/870,313, filed on Aug. 27, 2013.

(51) Int. Cl. G06F 19/18; G06N 99/00; G06F 19/00

(52) U.S. Cl. CPC G06F 19/18; G06F 19/3431; G06N 99/005
USPC 702/19

(57) ABSTRACT

The techniques described herein relate identification of disease-causing genetic variant by machine learning classification. The techniques may include receiving a training dataset of predetermined variants associated with disease. A hyperplane is identified having a maximum margin between points of the dataset. Patient input data is received including an observed variant of a gene. Features of the observed variant are selected, and a score is determined The score is determined using Support Vector Machine algorithms based on an observation of a novel non-linear relationship with the selected features of the observed variant. The observed variant may be classified based on the score indicating a distance of the observed variant from the identified hyperplane.

### CROSS REFERENCE TO RELATED APPLICATIONS

The present application claims priority to U.S. Provisional Patent Application No. 61/870,313, filed Aug. 27, 2013, which is incorporated herein by reference.

### FIELD OF THE INVENTION

The techniques described herein relate generally to classification and prediction algorithms. More specifically, the techniques described herein relate to support machine vector learning in classification of genetic variants.

### BACKGROUND OF THE INVENTION

Deoxyribonucleic acid (DNA) is a molecule that encodes the genetic instructions used in the development and functioning of all known living organisms and many viruses. DNA sequencing is the process of determining the precise order of nucleotides within a DNA molecule. Recently, DNA sequencing platforms have become more widely available. As a result, variant data on genomes from healthy subjects and patients are being generated at an unprecedented rate. However, the development of bioinformatics tools for handling this data lags behind, thus there are massive data quantities being generated without the necessary corresponding ability to fully exploit their biological contents. Bioinformatics is an interdisciplinary field that develops methods and software tools for understanding biological data. Many of today's analytic tools related to DNA sequencing offer limited annotation types due to limited database access of a given tool.

### BRIEF DESCRIPTION OF THE INVENTION

An embodiment relates to a method for identifying a disease-causing genetic variant by machine learning classification. The method may include receiving a training dataset of predetermined variants associated with disease. A hyperplane is identified having a maximum margin between points of the training dataset. The method may include receiving patient input data comprising an observed variant of a gene, and selecting features of the observed variant. A score, using Support Vector Machine learning algorithms, is determined based on an observation of a novel non-linear relationship with the selected features of the observed variant. The method may also include classifying the observed variant as deleterious or tolerable based on the score indicating a distance of the observed variant from the hyperplane.

Another embodiment relates to a system configured to identify a disease-causing genetic variant by machine learning classification. The system may include a processing device and a storage device. The storage device may include instructions thereon that, when executed by the processing device, cause the system to receive a training dataset of predetermined variants associated with a disease. The instructions may also identify a hyperplane having a maximum margin between points of the training dataset and receive patient input data comprising an observed variant. The instructions, when executed by the processing device, also cause the system to select features of the observed variant and determine a score using Support Vector Machine algorithms based on an observation of a novel non-linear relationship with the selected features of the observed variant. The observed variant may be classified as deleterious or tolerable based on the score indicating a distance of the observed variant from the hyperplane.

In yet another embodiment, a non-transitory computer-readable medium for identifying a disease-causing genetic variant by machine learning classification. The computer-readable medium includes processor-executable code to receive a training dataset of predetermined variants associated with a disease, and identify a hyperplane having a maximum margin between points of the training dataset and receive patient input data comprising an observed variant. The processor-executable code may be configured to select features of the observed variant and determine a score using Support Vector Machine algorithms based on an observation of a novel non-linear relationship with the selected features of the observed variant. The observed variant may be classified as deleterious or tolerable based on the score indicating a distance of the observed variant from the hyperplane.

### BRIEF DESCRIPTION OF THE DRAWINGS

The present techniques will become more fully understood from the following detailed description, taken in conjunction with the accompanying drawings, wherein like reference numerals refer to like parts, in which:

FIG. 1 illustrates a block diagram illustrating a computing system configured to classify an observed variant;

FIG. 2 is a diagram illustrating a computing environment wherein datasets and features are used to perform a classification;

FIG. 3A is a flow diagram illustrating the how an observed variant is classified;

FIG. 3B is a flow diagram illustrating features selected that may include a plurality of different values;

FIG. 4 is a diagram illustrating a method of determining a phenotype adjusted gene score and phenotype adjusted score;

FIG. 5 is a diagram illustrating a method of determining a family adjusted score; and

FIG. 6 is a block diagram of a computer readable medium that includes modules for identifying a possible disease-causing genetic variant by machine learning classification.

### DETAILED DESCRIPTION OF THE INVENTION

In the following detailed description, reference is made to the accompanying drawings that form a part hereof, and in which is shown by way of illustration of specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the embodiments described herein.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

Various embodiments provide techniques for identifying a disease causing genetic variant by machine learning classification. In some cases, the techniques may include identifying a plurality of disease causing genetic variants by machine learning classification. In this case, the variants may be classified one by one. One or more datasets may be used to train a support vector machine. The dataset may be imported from a number of different databases and may include a number of different features. Based on the trained support vector machine a score may be determined using support vector machine algorithms based on an observation of a novel non-linear relationship between the features and the observed variant. The observed variant may be classified as deleterious or tolerable based on the score.

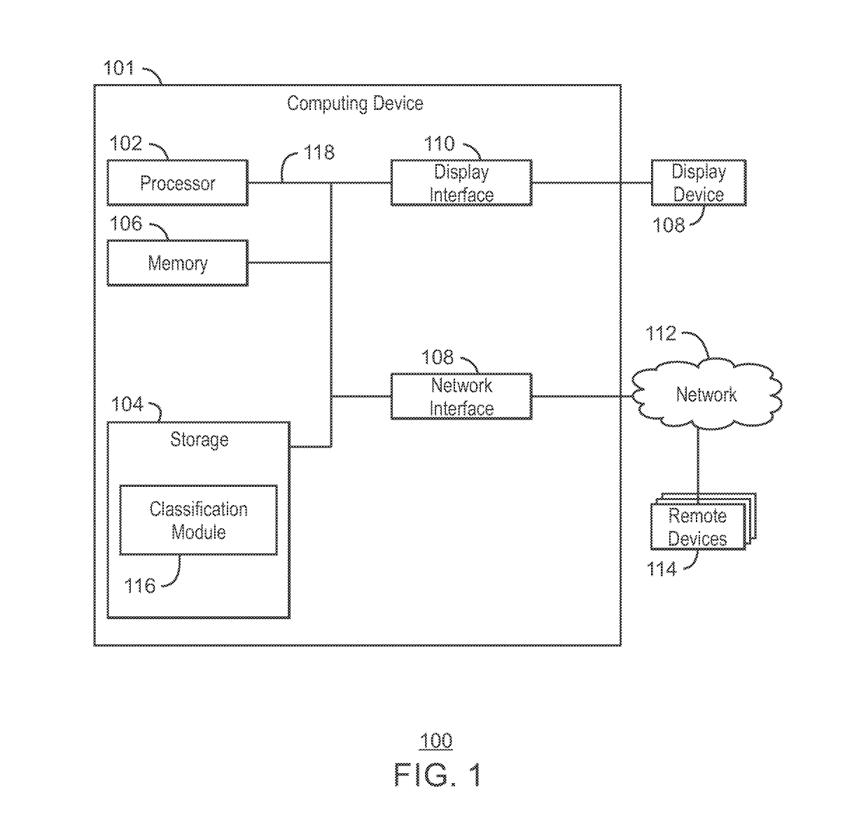

FIG. 1 illustrates a block diagram illustrating a computing system configured to classify an observed variant. The computing system 100 may include a computing device 101 having a processor 102, a storage device 104, a memory device 106, a network interface 107, a display device 108, and a display interface 110. The computing device 101 may communicate, via the network interface 107, with a network 112 to one or more remote devices 114.

The storage device 104 may be a non-transitory computer-readable medium having a classification module 116. The classification module 116 may be implemented as logic, at least partially comprising hardware logic, as firmware embedded into a larger computing system, or any combination thereof. The classification module 116 is configured to receive a training dataset of predetermined variants associated with a disease, identify a hyperplane having a maximum margin between points of the training dataset. The classification module 116 may also receive patient input data comprising an observed variant. In embodiments, an observed variant may be a variant of a gene of a patient. The classification module 116 may also select features of the observed variant.

In some scenarios, the features may be selected by a user of the classification module 116. A user may interact with the classification module 116 directly through the computing device 101 via a human input device (not shown), such as a keyboard, a mouse, a touch pad, and the like. In some cases, a user may interact with the classification module 116 via one of the remote devices 114 through the network 112. In this scenario, the network 112 may be a global network of computing devices such as the Internet.

The classification module 116 determines a score using Support Vector Machine algorithms based on an observation of a novel non-linear relationship with the selected features of the observed variant. The observed variant 116 may be classified as deleterious or tolerable based on the score indicating a distance of the observed variant from the hyperplane.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 106 can include random access memory (RAM) (e.g., static RAM, dynamic RAM, zero capacitor RAM, Silicon-Oxide-Nitride-Oxide-Silicon, embedded dynamic RAM, extended data out RAM, double data rate RAM, resistive RAM, parameter RAM, etc.), read only memory (ROM) (e.g., Mask ROM, parameter ROM, erasable programmable ROM, electrically erasable programmable ROM, etc.), flash memory, or any other suitable memory systems. The main processor 102 may be connected through a system bus 118 (e.g., PCI, ISA, PCI-Express, etc.) to the network interface 112. The network interface 107 may enable the computing device 101 to communicate, via the network 112, with the remote devices 114.

In embodiments, the computing device 101 may render images at the display device 108, via the display interface 110. The display device 108 may an integrated component of the computing device 101, a remote component such as an external monitor, or any other configuration enabling the computing device 101 to render a graphical user interface. As discussed in more detail below, a graphical user interface rendered at the display device 108 may be used in displaying an interface to a user of the computing device 101, wherein the interface provides a tool for identifying a disease-causing genetic variant by machine learning classification techniques.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

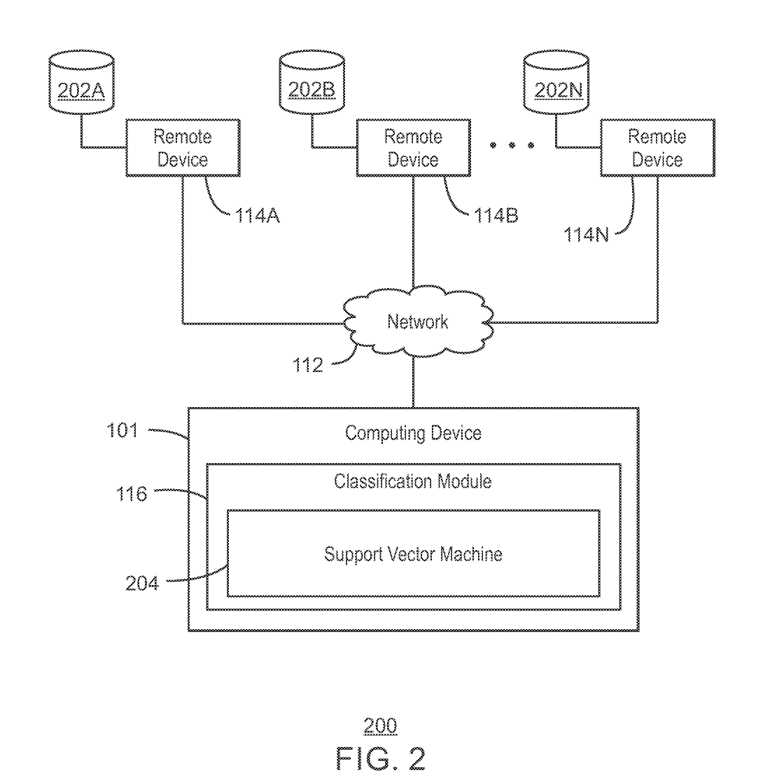

FIG. 2 is a diagram illustrating a computing environment wherein datasets and features are used to perform a classification. As discussed above in regard to FIG. 1, the computing device 101 may be communicatively coupled to the network 112, to a plurality of remote devices, such as remote devices 114A, 114B, and 114N. Each of the remote devices 114A-114N may be communicatively coupled to a respective database, 202A, 202B through 202N.

Each of the databases 202A-202N may provide a number of different datasets used by the classification module 116. As indicated in FIG. 2, the classification module 116 may include one or more sub-modules. Specifically, the classification module 116 may include a Support Vector Machine (SVM) 204 wherein the datasets from one or more of the databases 202A-202N may be used to train the SVM 204. The SVM 204 may be described as a computer algorithm that learns by example to assign labels to objects. In embodiments the SVM 204 may be configured to analyze data and recognize patterns based on databases 202A-202N. The SVM 204 identifies a hyperplane that separates data into one or more categories, such that a margin between points of the training datasets is a maximum margin between points of the training dataset.

The databases 202A-202N may include known damaging variants. Of the large number of gene annotations available, variants known to have damaging or deleterious effects may be used to train the SVM 204.

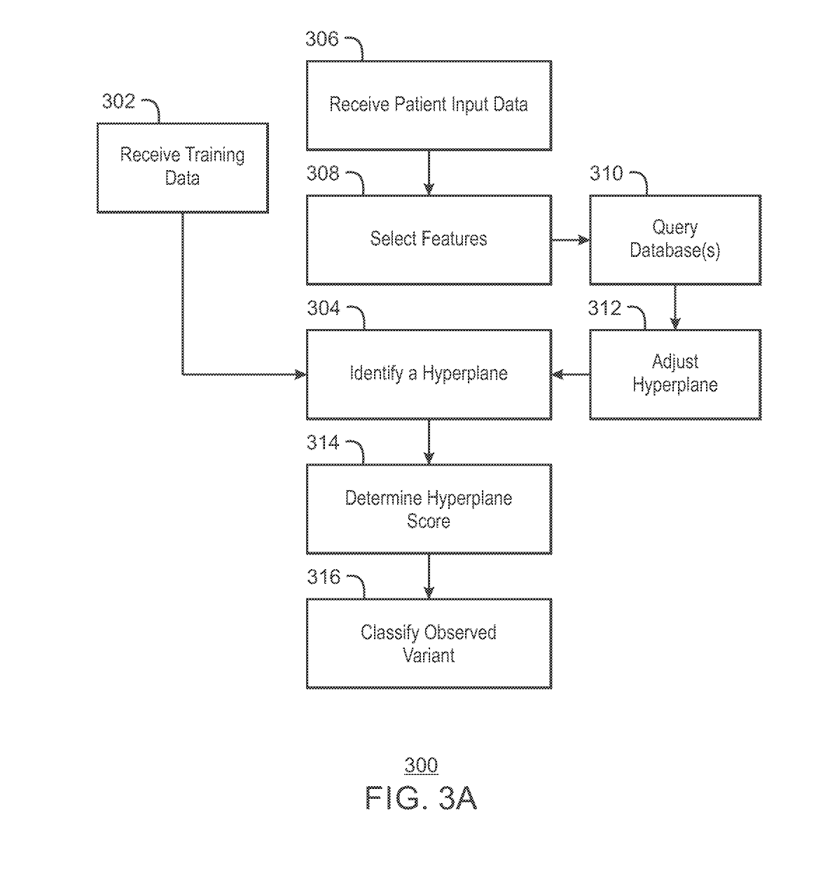

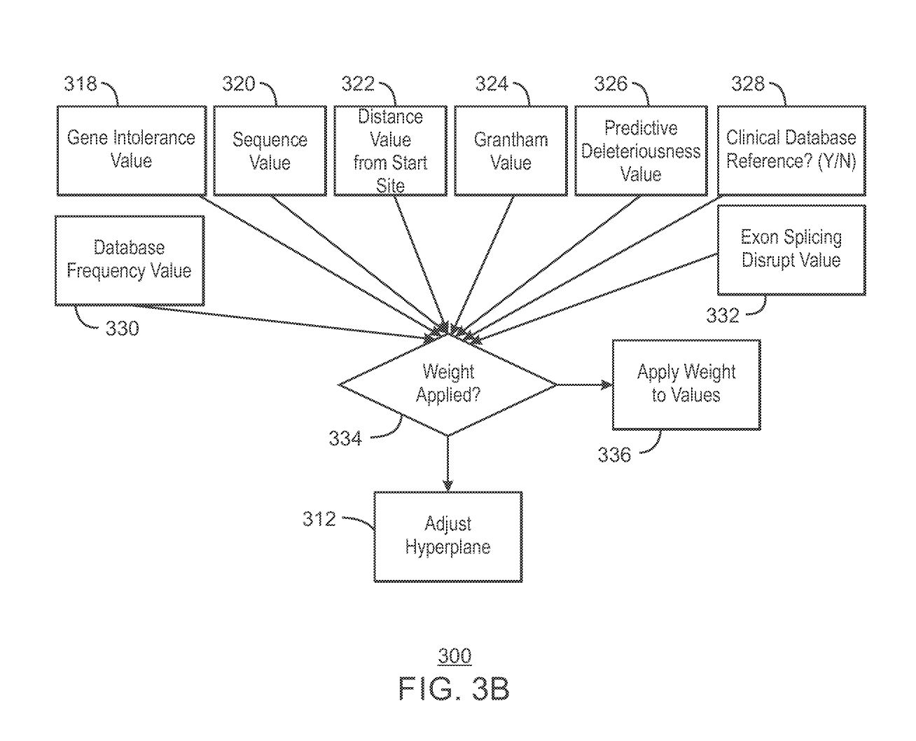

FIG. 3A is a flow diagram illustrating the how an observed variant is classified. At 302, training data is received. The training data received at 302 may include a plurality of data received from databases, such as the databases 202A-202N. At 304, a hyperplane is identified. As discussed above, the hyperplane may be identified by determining a maximum margin between points of the training data. At 306, patient input data is received. The patient input data may include an observed variant, such as a mutation, of a gene of the patient. The patient input data may be in a variety of formats such as variant call format (VCF) and the like.

Features associated with the observed variant are selected at 308. FIG. 3B is a flow diagram illustrating features selected that may include a plurality of different values. For example, the features may include a gene intolerance value 318 indicating the likelihood that variants in the gene cause a Mendelian disease. A Mendelian disease may be indicated by the existence of a particular locus in an inheritance pattern. Some examples of a Mendelian disease may include sickle-cell anemia, Tay-Sachs disease, cystic fibrosis, and the like.

Another feature may include a value 320 indicating a specific sequence characteristic. For example, whether a variant disrupts a regulatory sequence, causes an amino acid substitution, is located at an intron/exon boundary, and the like may be considered.

Another feature may include a distance value 322 indicating the distance of the observed variant to a transcription start site. For example, the distance of the observed variant from a gene sequence of which the observed variant is associated may indicate deleteriousness. A shorter distance may indicate that the gene has a higher possibility of deleteriousness to the gene.

Another feature may include a likelihood value 324 indicating that an amino acid substitution is associated with a disruption of the protein of the observed variant. For example, the feature selected may include a Grantham value wherein the effect of substitutions between amino acids may be predicted as a percentage, or as a value between 0 and 1.

Another feature may include a predictive deleteriousness value 326 of an algorithm. For example, a predictive deleteriousness score may include a scale invariant feature transform (SIFT) value. Other predictive deleteriousness scores may be used including a Polymorphism Phenotyping value, or a value indicating the disease-causing potential of sequence alterations. Additionally, the predictive deleteriousness score may be based on a multiple sequence alignment (MSA) partitioned to reflect functional specificity, and wherein conservation scores for each column represent the functional impact of a missense variant. The predictive deleteriousness score may also include a Functional Analysis through Hidden Markov Model score, and/or a log likelihood ratio of the conserved relative to neutral model to measure the deleteriousness of a nonsynonymous Single Nucleotide Polymorphism, with the null model that each codon is evolving neutrally with no difference in the rate of nonsynonymous to synonymous substitution and the alternative model that the codon has evolved under negative selection with a free parameter for the nonsynonymous to synonymous ratio. In embodiments, the predictive deleteriousness score is based on a combination of the scores discussed above, and may be an average, a mean, or a sum of the feature scores discussed above.

Another feature may be the presence or absence of the observed variant in clinical databases as indicated at 328. For example, clinical databases may be searched to discover whether the observed variant is referenced in the clinical database. The databases may include ClinVar databases, genome-wide association study (GWAS) databases, Associated Regional University Pathologists (ARUP) databases, Invitae databases, and Emory's databases.

Another feature may include a frequency value 330 of the observed variant in population databases. For example, the frequency of occurrence of the observed variant in populations such as the 1000 Genome Project, the National Heart, Lung, and Blood Exome Sequencing Project, and the like.

Another feature may include a value 332 indicating whether a variant disrupts the splicing of an exon. An exon is any nucleotide sequence encoded by a gene that remains present within the final mature RNA product of that gene after introns have been removed by RNA splicing. An intron is any nucleotide sequence encoded by a gene which is not present in the final mature RNA product of that gene. Specific classes of nucleotide sequences located within introns near exon/intron boundaries contribute to the proper splicing of gene products. These features include, a donor site (5′ end of the intron) almost always an invariant GU, a branch site (near the 3′ end of the intron) a region high in pyrimidines (C and U) called the polypryrimidine tract, and an acceptor site (3′ end of the intron) nearly always an invariant AG. Variants near exon/intron boundaries which disrupt the donor site, acceptor site, or branch site may interfere with proper exon splicing.

In some cases, features may be weighted at 336. Therefore, at 334 it is determined whether a feature should be weighted. If any of the features are to be weighted, a weight is applied at 336, and if not, the process flows to 312 wherein the hyperplane is adjusted 312.

Referring back to FIG. 3A, at 310, databases related to the deleteriousness score are queried, and the hyperplane may be adjusted based on the deleteriousness score at 312. At 314, a hyperplane score is determined The hyperplane score may be based on an observation of a novel non-linear relationship with the selected features and/or the selected feature score. The observation of a novel non-linear relationship with selected features of the observed variant includes a linear separability derived from an expanded input feature space of one or more kernel functions. In embodiments, the hyperplane score may indicate a distance of the observed variant from the hyperplane. At 316, the observed variant is classified based on the hyperplane score. More specifically, the hyperplane may distinguish between data points in view of the selected features by grouping the data points into two or more groups. The classification at 316 may place the observed variant into a group. The groups may be either deleterious or tolerable, based on the SVM classification using the hyperplane identified at 304, and adjusted at 308.

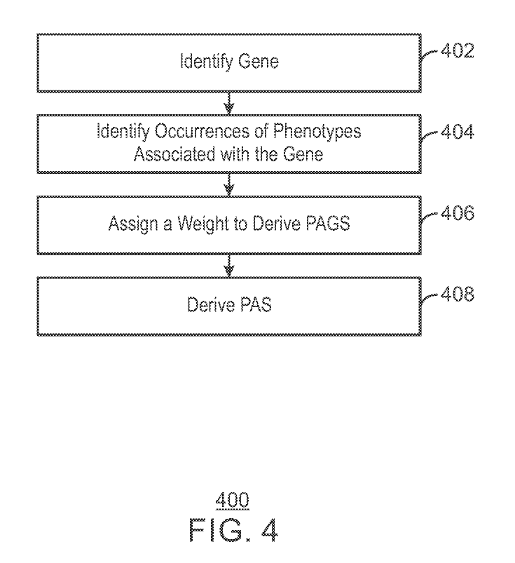

FIG. 4 is a diagram illustrating a method of determining a phenotype adjusted gene score and phenotype adjusted score. The phenotype adjusted gene score (PAGS) may be a predictive measure of the deleterious effect of the observed variant at the gene level. The PAGS value is derived by identifying the gene containing the observed variant at block 402. At block 404, occurrences of phenotypes associated with the gene within one or more databases are identified. At block 406, a weight is assigned based on the level of supporting evidence reported within these databases. At block 408, the phenotype adjusted score (PAS) is derived. The PAS may be thought of as the square root, or geometric mean, of the PAGS value and the hyperplane score as indicated in Equation 1 below:

PAS=√(PAGS×Hyperplane Score) (1)

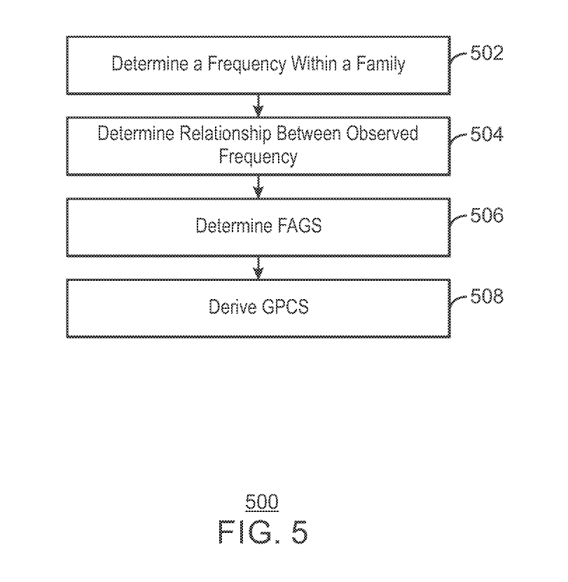

FIG. 5 is a diagram illustrating a method of determining a family adjusted score. The family adjusted score (FAS) is a predictive measure of the deleterious effect of an individual variant adjusted by the variants frequency within a family. In some embodiments, FAS is calculated by weighting a co-segregation pattern of a chromosomal region harboring the variants with disease phenotypes in the family. Other embodiments are considered. At block 502, a frequency of the observed variant within a family is determined At block 504, a family adjusted score of the observed variant based on a relationship between determined hyperplane score and the determined frequency within the family is determined The relationship determined at 504 may be based on Equation 2 below:

FAS=Hyperplane Score×(frequency in case samples)×(1−frequency in control samples) (2)

A family adjusted gene score (FAGS) may also be determined at 506. The FAGS value may be determined by a summation of the FAS scores, as indicated in Equation 3:

FAGS=ΣFAS (3)

At block 508, a gene phenotype combined score (GPCS) is derived. The GPCS value may be determined by the calculating the square root of the FAGS and the PAGS values, as indicated in Equation 4:

GPCS=√(FAGS×PAGS) (4)

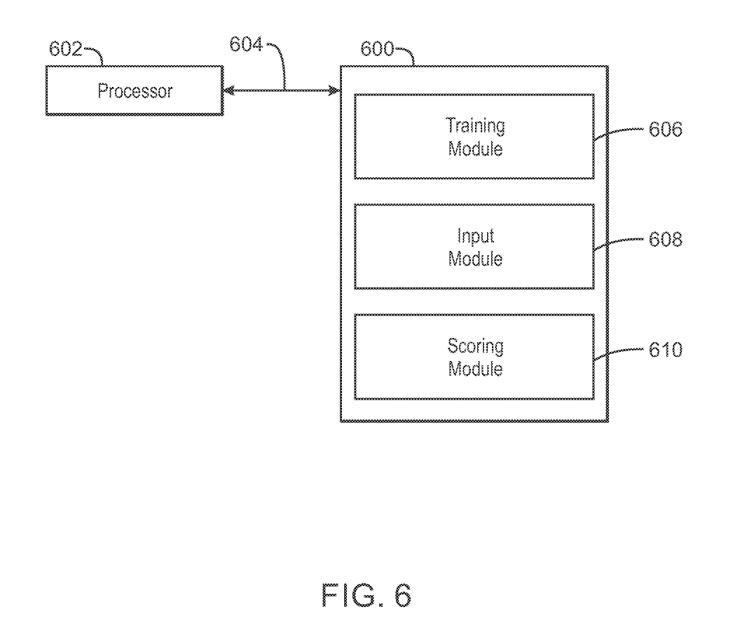

FIG. 6 is a block diagram of a computer readable medium that includes modules for identifying a possible disease-causing genetic variant by machine learning classification. The computer readable medium 800 may be a non-transitory computer readable medium, a storage device configured to store executable instructions, or any combination thereof. In any case, the computer-readable medium is not configured as a carry wave or a signal.

The computer-readable medium 800 includes code adapted to direct a processor 802 to perform actions. The processor 802 accesses the modules over a system bus 804.

A training module 806 may be configured to receive a training dataset of predetermined variants associated with a disease. The training module 806 may also be configured to identify a hyperplane having a maximum margin between points of the training dataset. An input module 808 may be configured to receive patient input data comprising an observed variant. An assignment module 810 may be configured to select features of the observed variant, determine a score using Support Vector Machine algorithms based on an observation of a novel non-linear relationship with the selected features of the observed variant, and classify the observed variant as deleterious or tolerable based on the score indicating a distance of the observed variant from the hyperplane.

The embodiments described herein include a web portal for receiving observed variant data. The techniques include rendering a human-readable annotation with links to external supporting evidence. In general, the techniques described herein include annotation, filtering and probabilistic modeling as discussed above. Presentation of an annotation includes determining the functional significance of variants including annotating single nucleotide variants (SNVs) and insertion/deletions of their effects on genes, reporting their conservation levels, such as PhyloP and GERP++ scores, calculating their predicted functional importance scores (such as SIFT and PolyPhen scores), determining if the variant disrupt transcription factor binding sites or microRNA target sites, querying multiple known disease databases to see if the variant is previously associated with a Mendelian disease, and retrieving allele frequencies in public databases (such as the 1000 Genomes Project and NHLBI-ESP 5400 exomes).

Filtering may refer to one of the methods to identify disease causal variants including a stepwise reduction approach. When searching for a disease causing mutations, users have the flexibility to specify either a set of default pipelines or a customized pipeline for variants filtering and reduction. For successfully reducing the high number of sequence variants, one may adapt and combine a variety of filters, such as variant frequency filters, functional prediction filters, genetic inheritance filters, and biological knowledge filters. This will result in a small set of potentially disease relevant mutations. Every filtering step is logged and thus allows the user to reproduce data processing.

Input fields may include a sample identifier, an email address, a variant file or several variant files, the detailed description of the phenotype, the reference genome build, the gene definition system, and a disease model for running the “variants prioritization” pipeline. The default input format for variant file is VCF, but other formats are supported.

Probabilistic model refers to an alternative method to score all genes in a personal genome by their likelihood of causing particular Mendelian phenotypes. This method involves the use of robust statistical models that incorporate all currently known information on annotation of genetic variants. The advantage is that candidate genes and variants are not discarded arbitrarily, but are instead assigned a likelihood score.

A machine-learning approach to rapidly prioritize clinically relevant genetic variants and genes. The machine-learning approach, as described above, may be based on support vector machine (SVM), to prioritize disease variants and genes, and integrate this functionality into a web application for improving annotation of clinically relevant variants and genes.

The SVM model building has been implemented in several distinct steps. First, we identified a set of functional prediction scores for which coding and non-coding variants can be assigned into. Second, we built and tested SVM prediction models, using a variety of kernel functions and other parameters. Third, we optimized the SVM models using known disease causal variants from our test data sets. For gene-based SVM model, we additionally require several factors, including hypothetical disease model, prior odds for genes based on phenotypes (see below), and SVM scores for top N variants in the gene. To comprehensively evaluate the false positive and negative rates of the approaches, we have generated synthetic data sets, by supplementing healthy genomes with known disease causal variants or genes under a variety of disease models.

In the web application, the “phenotype descriptors” in addition to just a suspected disease name, such as “Ogden syndrome” may be implemented. Phenotype descriptor refers to a set of terms describing multiple aspects of abnormal phenotypes for each patient, such as “aged appearance, craniofacial anomalies short columella, protruding upper lip, and microretrognathia.” Given the set of phenotype descriptors, we may identify a set of candidate genes that have stronger “prior” odds of association with the disease, so that we can have a more accurate posterior ranking of disease genes after examining genetic data.

Thus, the techniques may be used to help discover the prevalence of genetic diseases as well as decipher which genes are actually contributing to phenotypic changes. These discoveries will help establish causation and penetrance for disease causal variants and genes. By engaging consumers and patients, each of whom may have limited knowledge on genetics (but are motivated to research specific topics), we may collectively explore genomes and information contained therein, as well as better understand the clinical significance of genome variants. Developing a web presence of consumer-driven genome interpretation therefore becomes especially important for community engagements. The techniques offer a “Consumer Portal” specifically for this purpose, where consumers can share genetic and phenotypic information, comment on variants/genes via wiki-like mechanism, and collectively help each other understand the clinical significance of personal genomes.

While the detailed drawings and specific examples given describe particular embodiments, they serve the purpose of illustration only. The systems and methods shown and described are not limited to the precise details and conditions provided herein. Rather, any number of substitutions, modifications, changes, and/or omissions may be made in the design, operating conditions, and arrangements of the embodiments described herein without departing from the spirit of the present techniques as expressed in the appended claims.

This written description uses examples to disclose the techniques described herein, including the best mode, and also to enable any person skilled in the art to practice the techniques described herein, including making and using any devices or systems and performing any incorporated methods. The patentable scope of the techniques described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for identifying a possible disease-causing genetic variant by machine learning classification, comprising:
receiving a training dataset of predetermined variants associated with disease;
identifying a hyperplane having a maximum margin between points of the training dataset;
receiving patient input data comprising an observed variant of a gene;
selecting features of the observed variant;
determining a hyperplane score using Support Vector Machine algorithms based on an observation of a novel non-linear relationship with the selected features of the observed variant; and
classifying the observed variant as deleterious or tolerable based on the score indicating a distance of the observed variant from the hyperplane.

2. The method of claim 1, wherein the features comprise one or more of:
a value indicating the likelihood that the gene of the observed variant causes disease;
a value or values indicating specific sequence features;
a distance value indicating the distance of the observed variant to a transcription start site;
a likelihood that an amino acid substitution is associated with a disruption of the protein of the observed variant;
a predictive deleteriousness value of an algorithm;
a presence or absence of the observed variant in clinical databases;
a frequency of the observed variant in population databases;
a value indicating whether the variant disrupts intronic sequences controlling the proper splicing of the gene.

3. The method of claim 1, wherein the observation of a novel non-linear relationship with the selected features of the observed variant comprises a linear separability derived from an expanded input feature space of one or more kernel functions.

4. The method of claim 1, further comprising determining a phenotype adjusted gene score, wherein determining a phenotype score comprises:
identifying the gene containing the observed variant;
identifying occurrences of phenotypes associated with the gene within one or more databases; and
assigning a weight according to the relevance of the association.

5. The method of claim 1, further comprising determining a phenotype adjusted score, wherein determining a phenotype adjusted score comprises the square root of the multiplication of the hyperplane score by the phenotype adjusted gene score.

6. The method of claim 1, further comprising determining a family adjusted score, wherein determining a family adjusted score comprises:
determining a frequency of the observed variant within a family;
determining a family adjusted score of the observed variant based on a relationship between determined hyperplane score and the determined frequency within the family.

7. The method of claim 6, further comprising determining a family adjusted gene score, wherein determining a family adjusted gene score comprises aggregation of the family adjusted score of all variants which locate in the gene.

8. The method of claim 7, further comprising determining a gene phenotype combined score, wherein determining the gene phenotype combined score comprises the square root of the multiplication of the family adjusted gene score by the phenotype adjusted gene score.

9. A system for identifying a possible disease-causing genetic variant by machine learning classification, comprising:
a processing device;
a storage device having instructions thereon that, when executed by the processing device, cause the system to:
receive a training dataset of predetermined variants associated with a disease;
identify a hyperplane having a maximum margin between points of the training dataset;
receive patient input data comprising an observed variant;
select features of the observed variant;
determine a score using Support Vector Machine algorithms based on an observation of a novel non-linear relationship with the selected features of the observed variant; and
classify the observed variant as deleterious or tolerable based on the score indicating a distance of the observed variant from the hyperplane.

10. The system of claim 1, wherein the features comprise one or more of:
a value indicating the likelihood that the gene of the observed variant causes disease;
a value or values indicating specific sequence features;
a distance value indicating the distance of the observed variant to a transcription start site;
a likelihood that an amino acid substitution is associated with a disruption of the protein of the observed variant;
a deleteriousness value of an algorithm;
a presence or absence of the observed variant in clinical databases;
a frequency of the observed variant in population databases;
a value indicating whether the variant disrupts intronic sequences controlling the proper splicing of the gene.

11. The system of claim 10, wherein the data of the features are based on data of third party databases.

12. The system of claim 9, wherein the observation of a novel non-linear relationship with the selected features of the observed variant comprises a linear separability derived from an expanded input feature space of one or more kernel functions.

13. The system of claim 9, the storage device further comprising instructions to cause the processing device to determine a phenotype adjusted gene score, wherein determining a phenotype score comprises:
identifying the gene containing the observed variant;
identifying occurrences of phenotypes associated with the gene within one or more databases; and
assigning a weight according to the relevance of the association.

14. The system of claim 9, the storage device further comprising instructions to cause the processing device to determine a phenotype adjusted score, wherein determining a phenotype adjusted score comprises the square root of multiplying the hyperplane score by the phenotype adjusted gene score.

15. The system of claim 9, the storage device further comprising instructions to cause the processing device to determine a family adjusted score, wherein determining a family adjusted score comprises:
determining a frequency of the observed variant within a family;
determining a family adjusted score of the observed variant based on a relationship between determined hyperplane score and the determined frequency within the family.

16. The system of claim 15, the storage device further comprising instructions to cause the processing device to determine a family adjusted gene score, wherein determining a family adjusted gene score comprises aggregation of the family adjusted score of all variants which locate in the gene.

17. The system of claim 16, the storage device further comprising instructions to cause the processing device to determine a gene phenotype combined score, wherein determining the gene phenotype combined score comprises the square root of multiplying the family adjusted gene score by the phenotype adjusted gene score.

18. A non-transitory computer-readable medium for identifying a possible disease-causing genetic variant by machine learning classification, the computer-readable medium comprising processor-executable code to:
receive a training dataset of predetermined variants associated with a disease;
identify a hyperplane having a maximum margin between points of the training dataset;
receive patient input data comprising an observed variant;
select features of the observed variant;
determine a score using Support Vector Machine algorithms based on an observation of a novel non-linear relationship with the selected features of the observed variant; and
classify the observed variant as deleterious or tolerable based on the score indicating a distance of the observed variant from the hyperplane.

19. The computer-readable medium of claim 18, wherein the features comprise one or more of:
a value indicating the likelihood that the gene of the observed variant causes disease;
a value or values indicating specific sequence features;
a distance value indicating the distance of the observed variant to a transcription start site;
a likelihood that an amino acid substitution is associated with a disruption of the protein of the observed variant;
a deleteriousness value of an algorithm;
a presence or absence of the observed variant in clinical databases;
a frequency of the observed variant in population databases;
a value indicating whether the variant disrupts intronic sequences controlling the proper splicing of the gene.

20. The computer-readable medium of claim 18, wherein the data of the features are based on data of third party databases, wherein the observation of a novel non-linear relationship with the selected features of the observed variant comprises a linear separability derived from an expanded input feature space of one or more kernel functions.

21. The computer-readable medium of claim 18, the computer-readable medium further comprising processor-executable code to determine one or more of:
a phenotype adjusted gene score;
a phenotype adjusted score;
a family adjusted score, wherein determining a family adjusted score;
a family adjusted gene score; and
a gene phenotype combined score.
